(19) United States
(12) Patent Application Publication
(10) Pub. No.: US 2010/0071720 A1
(43) Pub. Date: Mar. 25, 2010

(54) METHOD AND SYSTEM FOR REMOVING CONTAMINANTS FROM A SURFACE

(75) Inventors: Dirk Heinrich Ehm, Lauchheim (DE); Stefan Schmidt, Aalen (DE); Dieter Kraus, Oberkochen (DE); Stefan Wiesner, Lauchheim (DE); Stefan Koehler, Rainau (DE); Almut Czap, Aalen (DE); Hin Yiu Anthony Chung, Elchingen (DE)

Correspondence Address: SUGHRUE MION, PLLC, 2100 PENNSYLVANIA AVENUE, N.W., SUITE 800, WASHINGTON, DC, 20037, US

(73) Assignee: Carl Zeiss SMT AG, Oberkochen (DE)

(21) Appl. No.: 12/234,447

(22) Filed: Sep. 19, 2008

(51) Int. Cl. B08B 5/04; B08B 7/00; C03C 25/70

(52) U.S. Cl. 134/2; 134/19; 134/21; 134/105; 134/199; 134/31

(57) ABSTRACT

Inside a vacuum chamber 200 a cleaning unit 204 provides atomic hydrogen or atomic deuterium for cleaning a surface 202 at a pressure of less than 10⁻⁴ Torr or of more than 10⁻³ Torr. The surface 202 is heated by the heating unit 203 to a temperature of at least 50° C. This allows achieving cleaning rates of more than 60 Å/h. Preferably, the surface 202 is the surface of a multilayer mirror 201 as used in an EUV lithography apparatus.

### FIELD OF THE INVENTION

The present invention relates to methods for removing contaminants from a surface. The present invention further relates to method for removing contaminants from a surface inside an EUV lithography apparatus. In addition, the present invention relates to a system for removing contaminants from a surface.

### BACKGROUND AND RELATED ART

Extreme ultraviolet (EUV) lithography apparatuses, i.e. lithography apparatuses working in an extreme ultraviolet wavelength range of approximately 1 nm to 20 nm, are mainly used for the production of semiconductor devices. For the illumination of a reticle and the projection of the reticle's structure onto e.g. a wafer, in particular reflective optical elements are utilized. During operation, the reflective optical elements in an EUV lithography apparatus are exposed to a radiation of up to 20 mW/mm² EUV photon density or more and to residual gases such as hydrocarbons, water, hydrogen, oxygen or others. The residual gases are split into fragments, which cause degradation and contamination of the multilayer surface, by irradiation with EUV photons or secondary electrons or by the influence of external electrical fields. The surface damage due to contamination by hydrocarbons reduces the reflectance of each reflective optical element. A relative reduction, for example, of 1% of each element's reflectance reduces the total monochromatic throughput of an EUV lithography apparatus with 10 reflective optical elements by 10%, which is quite significant.

Commonly, optical elements in EUV lithography apparatuses are cleaned from carbon-containing or other contamination by exposing the contaminated surface to gaseous species provided by cleaning units that react with the contamination to volatile substances that can be pumped away. An often-used gaseous species is atomic hydrogen that reacts with e.g. carbon contamination to volatile hydrocarbons or with metals to volatile hydrides.

US 2004/0011381 A1 describes a method using atomic hydrogen for removing carbon contamination from optical surfaces, in particular surfaces of multilayer optics used for EUV lithography. Atomic hydrogen at pressures in the range of about 10⁻³ and 10⁻⁴ Torr without heating of the optics is used to provide cleaning rates of about 6-60 Å/h.

It is one object of the present invention to provide alternative possibilities for cleaning contaminated surfaces, in particular surfaces inside lithography apparatuses.

### SUMMARY OF THE INVENTION

In a first aspect, the present invention provides a method for removing contaminants from a surface, which involves:

providing a vacuum chamber to house the contaminated surface;

injecting atomic hydrogen or atomic deuterium at a pressure of less than 10⁻⁴ Torr or more than 10⁻³ Torr; and

heating the surface to about 50° C. or more.

In a second aspect, the present invention provides a method for removing contaminants from a surface, which involves:

providing a vacuum chamber to house the contaminated surface;

injecting atomic deuterium.

In a third aspect, the present invention provides a system for removing contaminants from a surface, including:

a housing defining a vacuum chamber in which a surface to be cleaned is located; and

a source of atomic hydrogen or atomic deuterium capable of injecting atomic hydrogen or deuterium into the vacuum chamber, wherein the pressure of atomic hydrogen or atomic deuterium within the vacuum chamber is less than 10⁻⁴ Torr or more than 10⁻³ Torr, and wherein the surface is at a temperature of about 50° C. or more throughout the cleaning process.

In a fourth aspect, the present invention provides a system for removing contaminants from a surface, including:

a housing defining a vacuum chamber in which a surface to be cleaned is located; and

a source of atomic deuterium capable of injecting atomic deuterium into the vacuum chamber.

It has been found that heating the contaminated surface enhances the cleaning effect of atomic hydrogen or deuterium. Even for pressures below 10⁻⁴ Torr, high cleaning rates can be achieved. Particularly high cleaning rates can be achieved for pressures over 10⁻³ Torr. In particular, it has been found that deuterium reacts with many contaminants, inter alia carbon contaminants or metal contaminants to volatile compounds.

In a fifth aspect, the present invention provides a method for removing contaminants from a surface inside an EUV lithography apparatus by injecting atomic hydrogen or atomic deuterium inside the EUV lithography apparatus, wherein the cleaning rate is larger than 60 Å/hour. Also provided is a method for removing contaminants from a surface inside an EUV lithography apparatus by injecting atomic hydrogen or atomic deuterium inside the EUV lithography apparatus at a pressure of less than 10⁻⁴ Torr or more than 10⁻³ Torr and heating the surface to about 50° C. or more.

Certain preferred embodiments are described in the dependent claims.

### BRIEF DESCRIPTION OF THE DRAWINGS

A detailed description of the invention is provided below. This description is provided by way of a non-limiting example to be read with reference to the attached drawings in which:

FIG. 1 illustrates schematically an embodiment of an EUV lithography apparatus wherein contaminants can be removed from surfaces;

FIG. 2 illustrates schematically an embodiment of a system for removing contaminants from a surface;

FIGS. 3a-c illustrates schematically various examples of multilayer mirrors;

FIG. 4 is a flowchart of a first embodiment of a method for removing contaminants from a surface;

FIG. 5 is a flowchart of a second embodiment of a method for removing contaminants from a surface; and

FIG. 6 is a flowchart of an embodiment of a method for removing contaminants from a surface inside an EUV lithography apparatus.

### DETAILED DESCRIPTION OF PREFERRED EMBODIMENTS

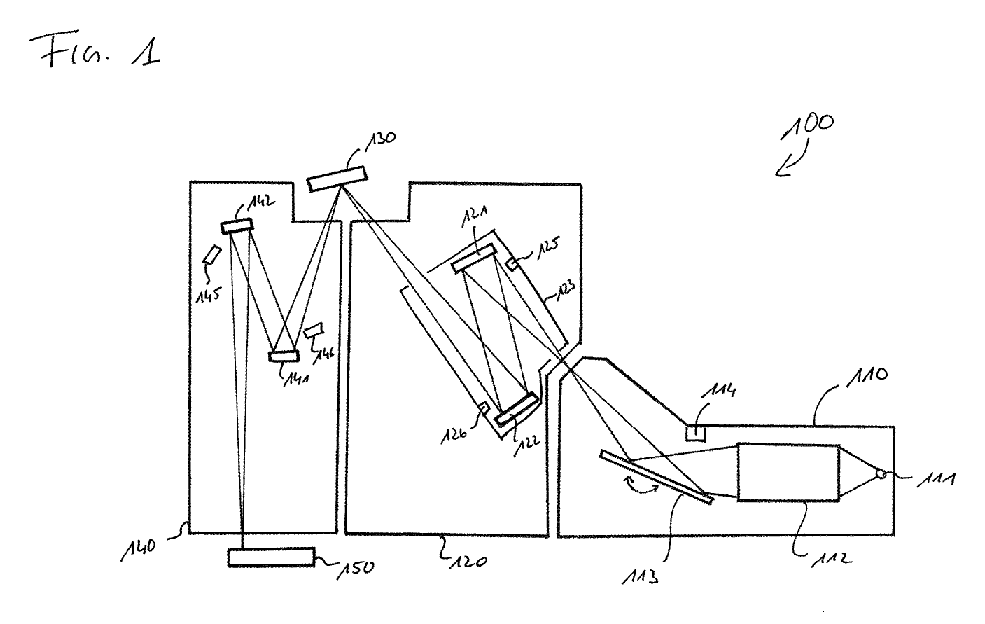

FIG. 1 shows schematically an EUV lithography apparatus 100. Its main components are the beam shaping system 110, the illumination system 120, the reticle 130 and the projection system 140. The housings of the beam shaping system 110, the illumination system 120 and the projection system 140 can define separate vacuum chambers.

The EUV source 111 may be a plasma source or a synchrotron. The radiation of the EUV source 111 has a wavelength in the range of about 1 nm to 20 nm. In the beam shaping system 110, the radiation is collimated in the collimator 112. Then, the monochromator 113 filters the desired wavelength needed for illuminating the reticle 130 and projecting the structure of the reticle onto the wafer 150 by varying the angle of incidence of the collimated beam. In the present wavelength range, normally, reflective optical elements such as multilayer mirrors are used as collimator 112 and monochromator 113 for shaping the beam with respect to wavelength and angular distribution. In particular, a collector mirror can be utilized as collimator 112.

The illumination system 120 illuminates the reticle 130 with the shaped beam by reflecting it in the present example with the help of two optical elements, specifically two multilayer mirrors 121, 122. Depending on the specific needs, there can also be only one or three, four, five or more reflective optical elements, if needed. The multilayer mirrors 121, 122 are encapsulated in a separate housing defining a further vacuum chamber 123 to avoid contamination of the multilayer mirrors 121, 122 as well as negative impact of the cleaning on components outside the encapsulated vacuum chamber 123.

To be useable with EUV radiation, the reticle 130 is a reflective optical element, too. The beam reflected by the reticle 130, respectively the structure of the reticle 130, is projected onto the wafer 150 by the projection system 140 with the help of two multilayer mirrors 141, 142. As in the illumination system 120, there can be as well only one or three, four, five or more reflective optical elements in the projection system 140, if needed.

In the vicinity of multilayer mirrors 113, 121, 122, 141, 142, cleaning units 114, 125, 126, 145, 146 are provided. In the present example, the cleaning units 114, 125, 126, 145, 146 provide atomic hydrogen or atomic deuterium for cleaning in particular carbon contamination from the mirrors 112, 113, 121, 122, 141, 142. In the present example, each mirror can have its own cleaning unit, as shown by way of example for the illumination system 120 or the projection system 140. But it is also possible to utilize a cleaning unit for several mirrors or an entire system, as shown by way of example for the beam shaping system 110. In further embodiments, the reticle 130 may be provided with a cleaning unit, too.

Hydrogen, in particular atomic hydrogen, is often used for cleaning optical elements, e.g. inside an EUV lithography apparatus from carbon contamination. Deuterium, in particular atomic deuterium, may be used as well. While hydrogen is readily available and less expensive, the pressure of deuterium is easier to control due to its larger mass. Both hydrogen and deuterium react with various contaminants to volatile reaction products that can be evacuated by the vacuum system around the surface to be cleaned. Tritium or atomic tritium may be used as well for removing contaminants.

The cleaning units that provide atomic hydrogen or atomic deuterium can be based on various processes for generating atomic hydrogen or atomic deuterium. One process is to use thermionic electrons from e.g. a hot filament. Other possibilities are the use of a plasma or of cold cathodes. It will be noted that the molecular hydrogen or molecular deuterium provided to the cleaning unit need not necessarily to be transformed completely into atomic hydrogen or atomic deuterium, but that molecular hydrogen or molecular deuterium may still be mixed with the atomic hydrogen or atomic deuterium used for cleaning. Especially, if the cleaning is done in situ in an EUV lithography apparatus with the EUV source being on for cleaning or regular lithography operation, part or all of the molecular hydrogen or molecular deuterium will be split by the EUV radiation into atomic hydrogen or atomic deuterium.

The surface to be cleaned, e.g. the surface of a multilayer mirror or any other surface inside an EUV lithography apparatus, can be heated by various means. For example, a heating device can be provided in thermal contact with the surface, radiation of an infrared source can be used, or inside an EUV lithography apparatus, the EUV radiation can be utilized for heating the surface, especially with EUV sources providing a high intensity or for surfaces near to the EUV source. Several heating means may be combined. In case of using cleaning units with hot filaments, they can also be used for heating the surface to be cleaned.

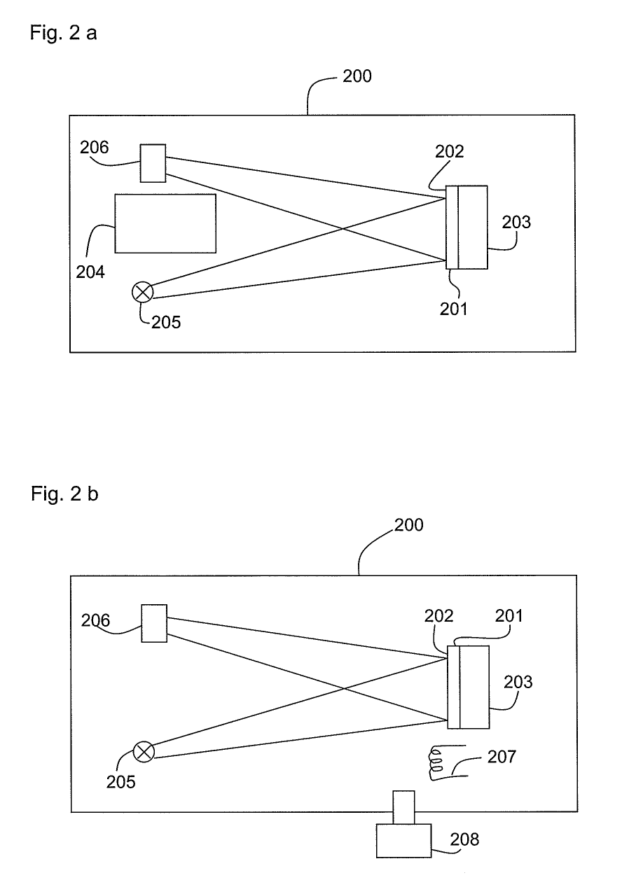

FIGS. 2a,b show schematically two embodiments of a cleaning system with a housing 200, inside of which a multilayer mirror 201 with a surface 202 to be cleaned is arranged. The surface 202 can be heated by a heating unit 203 adjacent to the rear side of the multilayer mirror 201 and/or by irradiation with EUV radiation from an EUV source 205. The heating unit 203 can be operated on the basis of any thermal conduction or thermal radiation principle. Using the heating unit 203 and/or the EUV radiation from the EUV source 205, the surface 202 to be cleaned is heated to 50° C. or more, preferably to 200° C. or more. Advantageously, the surface 202 is heated throughout the removal of the contaminants.

In the example illustrated in FIG. 2,a, the cleaning of the surface 202 is done with the help of a cleaning unit 204 providing atomic hydrogen or atomic deuterium. The process for generating atomic hydrogen or atomic deuterium can be based on thermionic electrons, on a plasma or on a cold cathode. In the example illustrated in FIG. 2b, a hot filament 207 is provided inside the vacuum chamber 200 to provide atomic hydrogen or atomic deuterium generated from molecular hydrogen or molecular deuterium fed into the vacuum chamber 200 near to the hot filament 207 through inlet 208, the hot filament 207 and the inlet 208 thus forming a cleaning unit. The molecular hydrogen or molecular deuterium is injected at a pressure of less than 10⁻² Torr or more than 10⁻¹ Torr.

The embodiments shown in FIGS. 2a,b can e.g. be part of an EUV lithography apparatus or be used as experimental set-up to clean surfaces of contaminated components, e.g. of EUV lithography apparatuses, ex situ. The actual state of contamination or cleaning can be monitored e.g. by measuring the reflectivity in the EUV range of the surface to be cleaned with the detector 206.

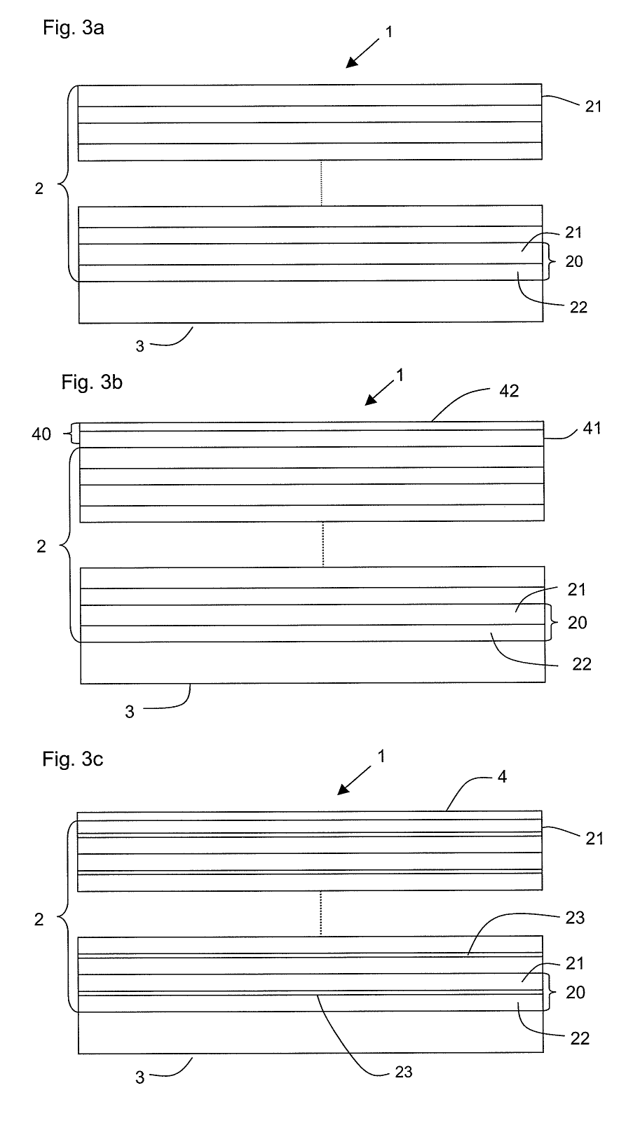

FIGS. 3a-c show schematically multilayer mirrors 1 having a multilayer system 2, which is deposited on a substrate 3. A multilayer system 2 consists basically of periodic stacks 20, each including a layer 21 of a material having a higher real part of the complex refraction index (also called spacer) and a layer 22 of a material having a lower real part of the complex refraction index (also called absorber). At each interface between spacer layers 21 and absorber layers 22, part of the EUV radiation is reflected. The thickness of the absorber layers 22 and particularly of the spacer layers 21 are chosen to allow for constructive interference of the reflected beam according to Bragg's Law.

It will be noted that a stack 20 may include more than two different layers and that the thicknesses of the stacks 20 may vary over the depth of the multilayer system 2. Eventually, there can be an additional capping layer 4 on top of the multilayer system 2 for protecting the multilayer system 2, especially its surface from contamination as well as cleaning. The capping layer 4 may be a capping system 40 comprising more than one layer 41, 42, e.g. a protective uppermost layer 42 and a matching layer 41 for optical match of the uppermost layer 42 to the layers 21, 22 of the multilayer system 2 to optimize the reflectance of the mirror 1.

As shown in the example of FIG. 3c, there can be a further layer 23 at the interface of spacer layer 21 on absorber layer 22, acting as barrier layer 23. The barrier layer 23 prevents diffusion and intermixing of spacer and absorber material. Barrier layers enhance optical contrast and thermal stability. Barrier layers can also be provided at the interface of absorber layer 22 on spacer layer 22 as well as at both interfaces.

In particular for use with EUV radiation, preferably at a wavelength between around 13 nm and 14 nm, the most preferred materials are silicon or beryllium for the spacer layers and molybdenum or molybdenum carbide for the absorber layers. Preferred materials for the capping layer are e.g. rhodium, palladium, ruthenium, molybdenum, indium, titanium, tin, zinc, their oxides, in particular ruthenium oxide or titanium oxide or aluminum oxide, their carbides, in particular molybdenum carbide, their nitrides, in particular ruthenium nitride or titanium nitride, their alloys, silicon nitride, silicon carbide, boron nitride, carbon, in particular diamond-like carbon or Buckminster fullerene or carbon that is adsorbed or implanted in a matrix, and combinations thereof. In case of more than one capping layer, preferred capping systems include e.g. a molybdenum and a ruthenium layer or a silicon nitride and a ruthenium layer. Concerning the barrier layers, preferred materials are e.g. boron carbide, silicon nitride or silicon boride. Multilayer mirrors on molybdenum/silicon basis with such barrier layers are particularly thermally stable and can be heated to over 500° C. without notably impairing the reflected intensity. They are well suited to be used as mirrors in an EUV lithography apparatus near to the EUV source, such as in the beam shaping system, in particular as collector mirror, or as one of the first mirrors in the illumination system. For lithography with high intensity EUV radiation, as is preferred to achieve a high production rate, preferably all mirrors have barrier layers.

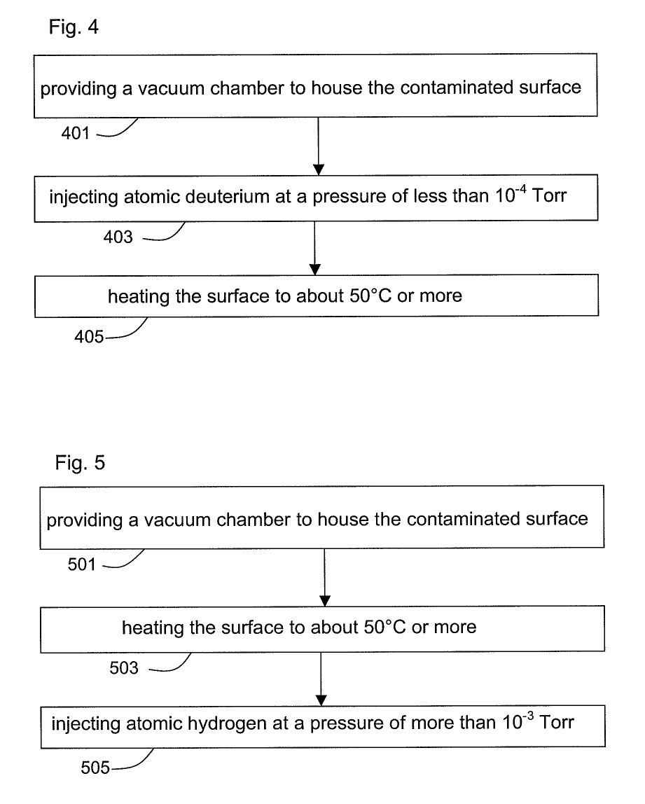

FIG. 4 shows as example a flowchart of a first embodiment of a method for removing contaminants from a surface. In a first step 401, a vacuum chamber to house the contaminated surface is provided. In the present example, atomic deuterium is injected at a pressure of less than 10⁻⁴ Torr (step 403). It would as well be possible to inject atomic hydrogen at a pressure of less than 10⁻⁴ Torr. In a further step 405, the surface to be cleaned is heated to about 50° C. or more, preferably 200° C. or more. In preferred embodiments, the surface is heated throughout the complete cleaning process. In further preferred embodiments, cleaning at pressures below 10⁻⁴ Torr is done inside an EUV lithography apparatus with pulsed EUV radiation. It is to be noted, that when using atomic deuterium, cleaning can be done at any pressures and at any temperatures of the surface to be cleaned.

FIG. 5 shows as example a flowchart of a second embodiment of a method for removing contaminants from a surface. In a first step 501, a vacuum chamber to house the contaminated surface is provided. Then, the surface to be cleaned is heated to about 50° C. or more, preferably 200° C. or more (step 503). In the present example, atomic hydrogen is injected at a pressure of more than 10⁻³ Torr (step 505). It would as well be possible to inject atomic deuterium at a pressure of more than 10⁻³ Torr. In preferred embodiments, the injecting of atomic hydrogen or atomic deuterium and the heating are proceeded with basically simultaneously. In further preferred embodiments, cleaning at pressures over 10⁻³ Torr is done inside an EUV lithography apparatus with high radiation intensity and/or high residual gas pressures.

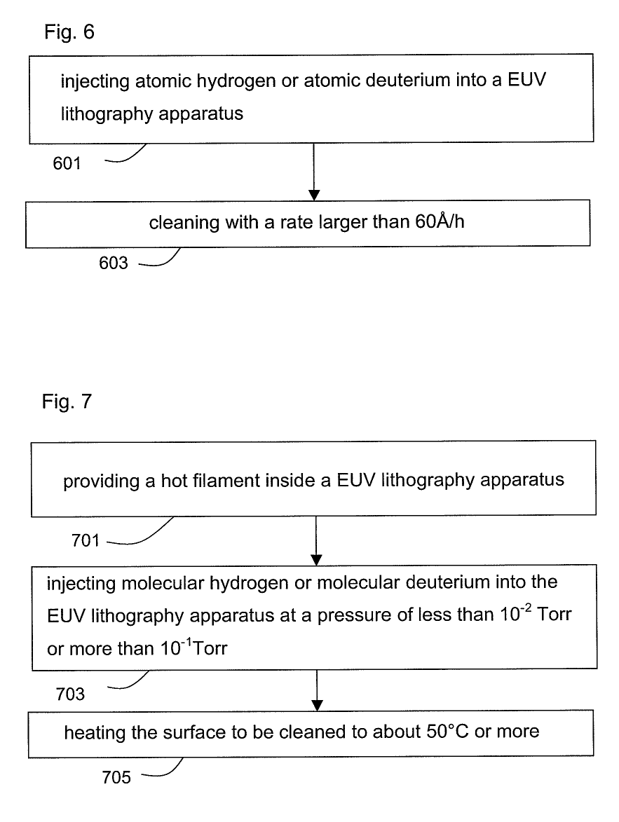

FIG. 6 shows as example a flowchart of an embodiment of a method for removing contaminants from a surface inside an EUV lithography apparatus, wherein atomic hydrogen or atomic deuterium is injected into an EUV lithography apparatus (step 601) and the cleaning is done with a rate larger than 60 Å/h (step 603). The surface to be cleaned can be the surface of a mirror, in particular of a multilayer mirror, or any other surface inside the EUV lithography apparatus. The surface to be cleaned can be e.g. inside the beam shaping system, the illumination system or the projection system of the EUV lithography apparatus or anywhere else inside the EUV lithography apparatus. In preferred embodiments, the EUV lithography apparatus as a whole or e.g. the beam shaping system, the illumination system or the projection system define a vacuum chamber housing the contaminated surface. Atomic hydrogen or atomic deuterium is injected into the chamber at a pressure of less than 10⁻⁴ Torr or more than 10⁻³ Torr while the surface is heated to about 50° C. or more. In other preferred embodiments, the pressure of the atomic hydrogen or the atomic deuterium is about 10⁻² Torr or higher and/or the surface is heated to ca. 200° C. or higher. Preferably, the contaminants are removed during operation of the EUV lithography apparatus, wherein the EUV lithography apparatus can be operated for cleaning purposes (one possibility of in-situ cleaning) or for lithography purposes (in operando cleaning). The EUV radiation of the EUV lithography apparatus is then utilized to heat the contaminated surfaces, especially if they are directly irradiated, like mirror surfaces, and to further split molecular hydrogen or deuterium to atomic hydrogen or deuterium that has not been split yet in the cleaning unit providing atomic hydrogen or deuterium. The EUV radiation can be continuous or pulsed.

FIG. 7 shows as example a flowchart of a further embodiment of a method for removing contaminants from a surface inside an EUV lithography apparatus, wherein a hot filament is provided inside the EUV lithography apparatus (step 701) for generating atomic hydrogen or atomic deuterium from molecular hydrogen or molecular deuterium that is injected into an EUV lithography apparatus at a pressure of less than 10⁻² Torr or more than 10⁻¹ Torr (step 703), while the surface to be cleaned is heated to about 50° C. (step 705).

Some examples of cleaning surfaces from contamination will be given, without restricting the scope of the appended claims.

### EXAMPLE 1

A molybdenum/silicon multilayer mirror with a capping system with a silicon nitride layer and a ruthenium layer has been heated to around 55° C. to 60° C. during 2.5 hours while atomic hydrogen was injected at a pressure of ca. 0.03 Torr at a flow of 1000 sccm and passing a hot filament of a temperature of ca. 1800° C., and a cleaning rate of 1.2 Å/h was achieved.

### EXAMPLE 2

A molybdenum carbide/silicon multilayer mirror with barrier layers of silicon boride has been heated to around 100° C. during 2.5 hours while atomic deuterium was injected at a pressure of ca. 0.03 Torr at a flow of 1000 sccm and passing a hot filament of a temperature of ca. 2000° C., and a cleaning rate of 3.5 Å/h was achieved.

### EXAMPLE 3

A molybdenum/beryllium multilayer mirror with barrier layers of boron carbide and with a rhodium capping layer has been heated to around 200° C. during 2 hours while atomic hydrogen was injected at a pressure of ca. 0.03 Torr at a flow of 2000 sccm and passing a hot filament of a temperature of ca. 2000° C., and a cleaning rate of 13 Å/h was achieved.

### EXAMPLE 4

A molybdenum carbide/beryllium multilayer mirror with barrier layers of boron carbide and with a capping system with a molybdenum layer and a ruthenium layer has been heated to around 500° C. during 1 hour while atomic hydrogen was injected at a pressure of ca. 0.15 Torr at a flow of 2000 sccm and passing a hot filament of a temperature of ca. 2000° C., and a cleaning rate of 31 Å/h was achieved.

### EXAMPLE 5

A molybdenum/silicon multilayer mirror with barrier layers of silicon boride and with a palladium capping layer has been heated to around 250° C. during 2 hours while atomic deuterium was injected at a pressure of ca. 0.15 Torr at a flow of 1000 sccm and passing a hot filament of a temperature of ca. 1800° C., and a cleaning rate of 2.7 Å/h was achieved.

### EXAMPLE 6

A molybdenum/silicon multilayer mirror with barrier layers of silicon nitride and with a ruthenium capping layer has been heated to around 400° C. during 1.5 hours while atomic hydrogen was injected at a pressure of ca. 0.15 Torr at a flow of 2000 sccm and passing a hot filament of a temperature of ca. 1800° C., and a cleaning rate of 11 Å/h was achieved.

### EXAMPLE 7

A molybdenum/silicon multilayer mirror with barrier layers of silicon nitride and with a capping layer of diamond-like carbon has been heated to around 300° C. during 1.5 hours while atomic hydrogen was injected at a pressure of ca. 0.15 Torr at a flow of 1000 sccm and passing a hot filament of a temperature of ca. 2000° C., and a cleaning rate of 8.1 Å/h was achieved.

### EXAMPLE 8

A molybdenum/silicon multilayer mirror with barrier layers of silicon boride and with a capping layer of titanium has been heated to around 450° C. during 1.5 hours while atomic hydrogen was injected at a pressure of ca. 0.40 Torr at a flow of 2000 sccm and passing a hot filament of a temperature of ca. 2000° C., and a cleaning rate of 65 Å/h was achieved.

### EXAMPLE 9

A molybdenum/silicon multilayer mirror with barrier layers of boron carbide and with a capping layer of iridium has been heated to around 500° C. during 2.5 hours while atomic hydrogen was injected at a pressure of ca. 0.45 Torr at a flow of 2000 sccm and passing a hot filament of a temperature of ca. 200° C., and a cleaning rate of 67 Å/h was achieved.

It will be noted that the surface of different multilayer mirrors or other surfaces can be cleaned with atomic hydrogen or atomic deuterium of various pressures as well at various temperature and the various high cleaning rates can be achieved without departing from the scope of the appended claims.

The above description of certain preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

1. A method for removing contaminants from a surface, comprising:
providing a vacuum chamber to house the contaminated surface;
injecting atomic hydrogen or atomic deuterium at a pressure of less than 10⁻⁴ Torr or more than 10⁻³ Torr; and
heating the surface to about 50° C. or more.

2. A method for removing contaminants from a surface, comprising:
providing a vacuum chamber to house the contaminated surface;
injecting atomic deuterium.

3. A method according to claim 2, wherein the atomic deuterium is injected at a pressure of less than 10⁻⁴ Torr or more than 10⁻³ Torr.

4. A method according to claim 2, wherein the surface is heated to about 50° C. or more.

5. The method according to claim 1, wherein the atomic hydrogen or the atomic deuterium is injected at a pressure of 10⁻² Torr or more.

6. The method according to claim 1, wherein the surface is heated throughout the removal of the contaminants.

7. The method according to claim 1, wherein the surface is heated to about 200° C. or more.

8. The method according to claim 1, wherein the contaminated surface is the surface of a multilayer optic.

9. The method according to claim 8, wherein the multilayer optic comprises:
as absorber material, one of the group consisting of molybdenum and molybdenum carbide; and as spacer material, one of the group consisting of silicon and beryllium.

10. The method according to claim 8, wherein the multilayer optic includes barrier layers comprising a material from the group consisting of boron carbide, silicon nitride and silicon boride.

11. The method according to claim 8, wherein the multilayer optic has a capping layer comprising a material from the group consisting of rhodium, palladium, ruthenium, molybdenum, indium, titanium, tin, zinc, their oxides, their carbides, their nitrides, their alloys, silicon nitride, silicon carbide, boron nitride, carbon, and combinations thereof.

12. The method according to claim 1, wherein the cleaning rate exceeds 60 Å/h.

13. The method according to claim 1, further comprising:
providing a hot filament, and
injecting molecular hydrogen or molecular deuterium at a pressure of less than 10⁻² Torr or more than 10⁻¹ Torr.

14. A system for removing contaminants from a surface in a cleaning process, comprising:
a housing defining a vacuum chamber in which a surface to be cleaned is located;
a source of atomic hydrogen or atomic deuterium configured to inject atomic hydrogen or deuterium into the vacuum chamber, wherein the pressure of the atomic hydrogen or atomic deuterium within the vacuum chamber is less than 10⁻⁴ Torr or more than 10⁻³ Torr; and
a heating element maintaining the surface at a temperature of about 50° C. or more during the cleaning process.

15. A system for removing contaminants from a surface, comprising:
a housing defining a vacuum chamber in which a surface to be cleaned is located; and
a source of atomic deuterium configured to inject the atomic deuterium into the vacuum chamber.

16. The system according to claim 15, wherein the pressure of atomic deuterium within the vacuum chamber is less than 10⁻⁴ Torr or more than 10⁻³ Torr.

17. The system according to claim 16, wherein the surface is at a temperature of about 50° C. or more.

18. The system according to claim 15, wherein the pressure of the atomic deuterium is 10⁻² Torr or more.

19. The system according to claim 14, wherein the surface is heated to about 200° C. or more.

20. The system according to claim 14, wherein the contaminated surface is the surface of a multilayer optic.

21. The system according to claim 20, wherein the multilayer optic comprises:
as absorber material, one of the group consisting of molybdenum and molybdenum carbide; and as spacer material, one of the group consisting of silicon and beryllium.

22. The system according to claim 20, wherein the multilayer optic includes barrier layers comprising a material from the group consisting of boron carbide, silicon nitride or silicon boride.

23. The system according to claim 20, wherein the multilayer optic has a capping layer comprising a material from the group consisting of rhodium, palladium, ruthenium, molybdenum, indium, titanium, tin, zinc, their oxides, their carbides, their nitrides, their alloys, silicon nitride, silicon carbide, boron nitride, carbon, and combinations thereof.

24. The system according to claim 14, wherein the housing is part of an EUV lithography apparatus.

25. The system according to claim 14, wherein the cleaning rate exceeds 60 Å/h.

26. The system according to claim 14, wherein the heating element comprises a hot filament and the pressure of molecular hydrogen or molecular deuterium within the vacuum chamber is less than 10⁻² Torr or more than 10⁻¹ Torr.

27. A method for removing contaminants from a surface inside an EUV lithography apparatus comprising injecting atomic hydrogen or atomic deuterium inside the EUV lithography apparatus, wherein the cleaning rate exceeds 60 Å/hour.

28. The method according to claim 27, wherein the atomic hydrogen or the atomic deuterium is injected at a pressure of less than 10⁻⁴ Torr or more than 10⁻³ Torr; and further comprising heating the surface to about 50° C. or more.

29. A method for removing contaminants from a surface inside an EUV lithography apparatus comprising:
injecting atomic hydrogen or atomic deuterium inside the EUV lithography apparatus at a pressure of less than 10⁻⁴ Torr or more than 10⁻³ Torr; and
heating the surface to about 50° C. or more.

30. The method according to claim 29, wherein the surface is heated throughout the removal of contaminants.

31. The method according to claim 29, wherein the surface is heated to about 200° C. or more.

32. The method according to claim 29, wherein the atomic hydrogen or the atomic deuterium is injected at a pressure of 10⁻² Torr or more.

33. The method according to claim 29, wherein the contaminated surface is the surface of a multilayer optic.

34. The method according to claim 33, wherein the multilayer optic comprises:
as absorber material, one of the group consisting of molybdenum and molybdenum carbide, and as spacer material, one of the group consisting of silicon and beryllium.

35. The method according to claim 33, wherein the multilayer optic includes barrier layers comprising a material from the group consisting of boron carbide, silicon nitride and silicon boride.

36. The method according to claim 33, wherein the multilayer optic has a capping layer comprising a material from the group consisting of rhodium, palladium, ruthenium, molybdenum, indium, titanium, tin, zinc, their oxides, their carbides, their nitrides, their alloys, silicon nitride, silicon carbide, boron nitride, carbon, and combinations thereof.

37. The method according to claim 29, further comprising:
providing a hot filament, and
injecting molecular hydrogen or molecular deuterium at a pressure of less than 10⁻² Torr or more than 10⁻¹ Torr.

38. The method according to claim 29, further comprising:
operating the EUV lithography apparatus during the removal of the contaminants.

39. The method according to claim 2, wherein the contaminated surface is the surface of a multilayer optic.

40. The method according to claim 2, wherein the cleaning rate exceeds 60 Å/h.

41. The method according to claim 2, further comprising:
providing a hot filament, and
injecting molecular hydrogen or molecular deuterium at a pressure of less than 10⁻² Torr or more than 10⁻¹ Torr.

42. The system according to claim 14, wherein the pressure of the atomic hydrogen or the atomic deuterium is 10⁻² Torr or more.

43. The system according to claim 15, wherein the contaminated surface is the surface of a multilayer optic.

44. The system according to claim 15, wherein the housing is part of an EUV lithography apparatus.

45. The system according to claim 15, wherein the cleaning rate exceeds 60 Å/h.

46. The system according to claim 15, further comprising:
a heating element maintaining the surface at a temperature of about 50° C. or more during the cleaning process, wherein the heating element comprises a hot filament and the pressure of molecular deuterium within the vacuum chamber is less than 10⁻² Torr or more than 10⁻¹ Torr.

47. The method according to claim 27, wherein the contaminated surface is the surface of a multilayer optic.

48. The method according to claim 27, further comprising:
providing a hot filament, and
injecting molecular hydrogen or molecular deuterium at a pressure of less than 10⁻² Torr or more than 10⁻¹ Torr.

49. The method according to claim 27, further comprising:
operating the EUV lithography apparatus during the removal of the contaminants.
